(19) United States
(12) Patent Application Publication
(10) Pub. No.: US 2008/0209038 A1
(43) Pub. Date: Aug. 28, 2008

(54) Methods and systems for optimizing placement on a clock signal distribution network

(75) Inventor: Andrew J. Tufano, Palo Alto, CA (US)

Correspondence Address: Stevens Law Group, 1754 Technology Drive, Suite #226, San Jose, CA, 95110, US

(73) Assignee: Raza Microelectronics, Inc., Cupertino, CA (US)

(21) Appl. No.: 11/710,249

(22) Filed: Feb. 23, 2007

(51) Int. Cl. G06F 1/12

(52) U.S. Cl. 709/225

(57) ABSTRACT

Methods for optimizing an initial placement a number of features over a clock signal distribution network on an integrated circuit (IC), wherein the plurality of features includes a plurality of registers and a corresponding plurality of local drivers are presented, the methods including: characterizing the number of features by a number of register groupings, the number of register groupings defined by similarity of corresponding local drivers, wherein each of the number of register groupings is physically delimited by a defined region on the clock signal distribution network in the initial placement; and iteratively moving the number of register groupings in accordance with a number of exception based rules over an increasingly widening area of comparison to create an optimized placement of the number of features.

### BACKGROUND

In digital computing systems, synchronization is critical to providing accurate data processing. A clock signal is used to define a temporal reference point that is utilized for synchronization. A clock distribution network provides a way for a clock signal to be effectively distributed across a defined processing system. Utilizing a clock distribution network assures that all components requiring synchronization may receive a common clock signal. Because of the criticality of providing an accurate and robust clock signal, design of a clock distribution network requires specialized techniques.

FIG. 1 is a prior art illustrative representation of a clock distribution network 100 in a clock tree synthesis. A number of clock drivers 102.0.1 to 102.N.M. may be provided to distribute (or fan out) a clock signal to any number of buffers 106.1 to 106.M, which include corresponding registers 110.1 to 110.M. Any number of levels of clock drivers 104.0 to 104.N may be utilized in order to provide sufficient signal to all components. One disadvantage to a clock tree synthesis as illustrated is that the number of levels can increase rapidly, which may adversely affect clock skew. In circuit design, clock skew is a phenomenon in synchronous circuits in which a clock signal (distributed over a clock distribution network) arrives at different components at different times. Ideally, all clock signals would arrive at all components at the same time. Other clock distribution network configurations are well-known in the art which may overcome some of the inherent disadvantages of a clock tree synthesis.

For example, FIG. 2 is a prior art illustrative representation of a clock distribution network 200 in a clock mesh synthesis. A clock mesh synthesis provides a grid like interconnection for any number of clock buffers 204.0.1 to 204.1.N. Clock buffers may be connected with a grid having a number of rows such as row 220 and a number of columns such as column 222. Additionally, any number of unqualified local drivers (i.e. unqualified local driver 208.1) and any number of qualified local drivers (i.e. qualified local drivers 206.1 and 206) may be connected with the grid via connections (i.e. connections 210 and 214). In turn, any number of registers 209.1 to 209.A and 207.1 to 207.M may be connected with corresponding local drivers. In this manner, a clock signal may be distributed over clock distribution network 200 with a minimum number of levels. As may be appreciated, a reduction in the number of levels may, in some examples, result in a reduction in clock skew.

Unfortunately, while clock tree synthesis models may be designed and configured utilizing a number of automated tools known in the art, clock mesh synthesis models must often be designed and configured by hand. As may be appreciated, because of the sheer number of components in a digital system requiring a clock signal, designing a clock mesh synthesis without automated tools may proceed in a sometimes haphazard manner. In some instances, poor grouping of components may result in longer signal paths which are susceptible to corruption and higher power consumption. It may be appreciated that some clock distribution networks such as a clock mesh synthesis may benefit from a more refined and automated grouping scheme that may result in shorter signal path and better power consumption.

As such, methods and systems for optimizing placement on a clock signal distribution network are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such, methods for optimizing an initial placement a number of features over a clock signal distribution network on an integrated circuit (IC), wherein the plurality of features includes a plurality of registers and a corresponding plurality of local drivers are presented, the methods including: characterizing the number of features by a number of register groupings, the number of register groupings defined by similarity of corresponding local drivers, wherein each of the number of register groupings is physically delimited by a defined region on the clock signal distribution network in the initial placement; and iteratively moving the number of register groupings in accordance with a number of exception based rules over an increasingly widening area of comparison to create an optimized placement of the number of features. In some embodiments, methods further include: placing the number of register groupings on the clock signal distribution network in accordance with the iteratively moving the number of register groupings; placing the corresponding number of local drivers on a clock row in accordance with the placing the number of register groupings; placing a number of clock drivers on a spine region, the number of clock drivers configured to provide the corresponding number of drivers a common clock signal; and placing a number of routes, the number of routes configured to connect the number of clock drivers with the corresponding number of local drivers and the number of corresponding local drivers with the number of register groupings. In some embodiments, methods are presented, wherein the increasingly widening area of comparison includes: a first level of comparison, wherein the first level of comparison requires that the number of exception based rules are strictly enforced, and wherein the number of exception based rules are iteratively and repeatedly applied across all defined regions until none of the number of exception based rules are enforceable, the first level of comparison corresponding with a first number of comparison regions, the first number of comparison regions located immediately adjacent with the defined region; a second level of comparison, wherein the second level of comparison requires that the number of exception based rules are strictly enforced, and wherein the number of exception based rules are iteratively and repeatedly applied across all defined regions until none of the number of exception based rules are enforceable, the second level of comparison corresponding with a second number of comparison regions and the first level of comparison regions, the second number of comparison regions located immediate adjacent with the first number of comparison regions; and a third level of comparison, wherein the third level of comparison requires that the number of exception based rules are selectively enforced, and wherein the number of exception based rules are iteratively and repeatedly applied across all defined regions until none of the number of exception based rules are enforceable, the third level of comparison corresponding with a third number of comparison regions, the second number of comparison regions, and the first number of comparison regions, the third number of comparison regions located immediate adjacent with the second number of comparison regions. In some embodiments, methods are presented, wherein the iteratively moving continues until an iteration condition is reached, wherein the iteration condition is selected from the group consisting of: an all exceptions cleared condition for an area of comparison, an all exceptions processed condition for the area of comparison, and a maximum number of iterations condition for the area of comparison.

In other embodiments, systems for optimizing an initial placement of a number of features over a clock signal distribution network on an integrated circuit (IC) layout, wherein the number of features includes a number of registers and a corresponding number of local drivers are presented, the systems including: a register transfer language (RTL) module for creating a number of code expressions in an RTL; a synthesis module for mapping the RTL to a number of logic circuits based on a first output from the RTL module; a floor plan module for determining a first physical space requirement for the clock signal distribution network based on a second output from the synthesis module; a clock grid design (CGD) floor plan module for defining a set of physical dimensions corresponding with the clock signal distribution network based on a third output from the floor plan module, the CGD floor plan module further configured for determining a second physical space requirement for the number of local drivers corresponding with the number of logic circuits; a placement module for creating the initial placement of the number of features, a CGD placement module for optimizing the initial placement, the CGD configured to, group the number of registers in accordance with a number of iteratively applied exception based rules, place the number of local drivers, and place a number of clock drivers; and a route module for establishing a number of connections between the number of registers, the number of local drivers, and the number of c wherein an optimized placement is output. In some embodiments, systems further include a CGD analysis module for determining an efficiency of an optimized placement.

In other embodiments, methods for optimizing an initial placement a number of features over a clock signal distribution network on an integrated circuit (IC), wherein the number of features includes a number of registers and a corresponding number of local drivers are presented, the methods including: means for characterizing the number of features by a number of register groupings, the number of register groupings defined by similarity of corresponding local drivers, wherein each of the number of register groupings is physically delimited by a defined region on the clock signal distribution network in the initial placement; and means for iteratively moving the number of register groupings in accordance with a number of exception based rules over an increasingly widening area of comparison to create an optimized placement of the number of features. In some embodiments, methods further include: means for placing the number of register groupings on the clock signal distribution network in accordance with the means for iteratively moving the number of register groupings; means for placing the corresponding number of local drivers on a clock row in accordance with the placing the number of register groupings; means for placing a number of clock drivers on a spine region, the number of clock drivers configured to provide the corresponding number of drivers a common clock signal; and means for placing a number of routes, the number of routes configured to connect the number of clock drivers with the corresponding number of local drivers and the number of corresponding local drivers with the number of register groupings. In some embodiments, methods further include means for generating a quality report for determining a number of performance characteristics corresponding with the optimized placement.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a prior art illustrative representation of a clock distribution network 100 in a clock tree synthesis;

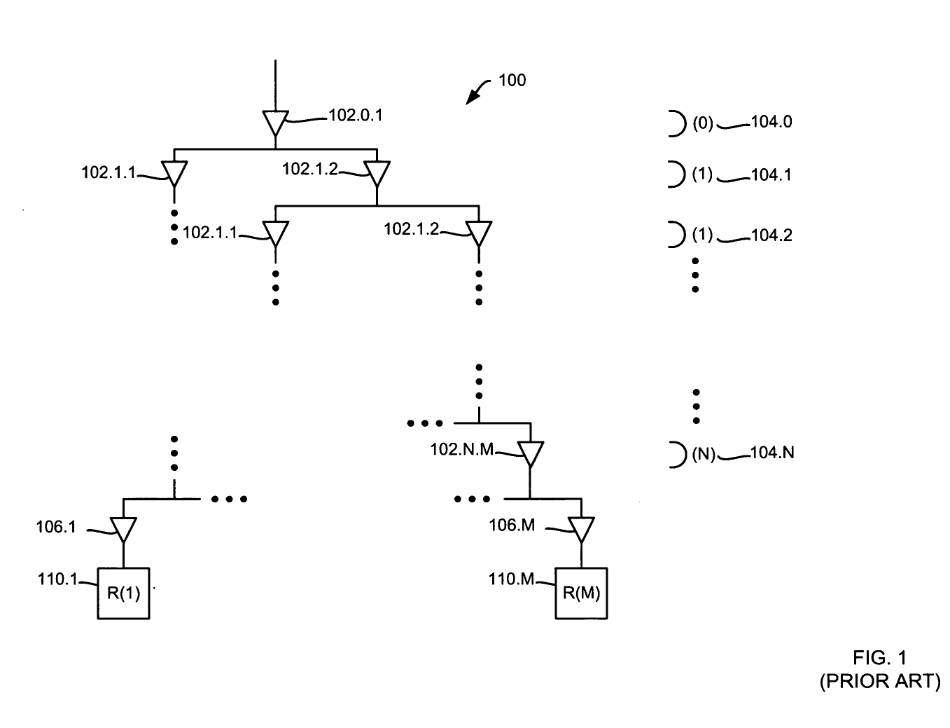

FIG. 2 is a prior art illustrative representation of a clock distribution network in a clock mesh synthesis;

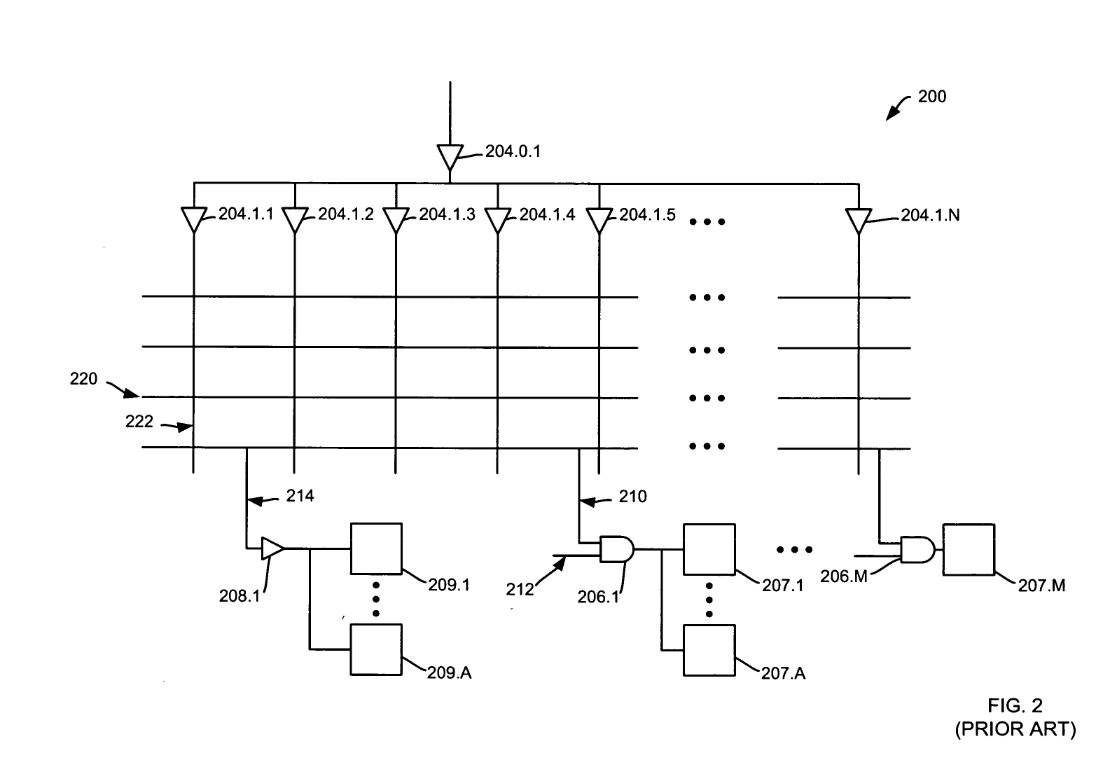

FIG. 3 is a flowchart illustrating an overview of creating an optimized clock distribution network in accordance with embodiments of the present invention;

FIG. 4 is an illustrative representation of a clock mesh synthesis in accordance with embodiments of the present invention;

FIG. 5 is a flowchart further illustrating arranging features on a clock distribution network in accordance with embodiments of the present invention;

FIG. 6 is a flowchart illustrating methods of applying iterative exception based rules in accordance with embodiments of the present invention;

FIG. 7 is an illustrative representation of widening areas of comparison in accordance with embodiments of the present invention;

FIG. 8 is a flowchart illustrating methods of applying exception based rules in accordance with embodiments of the present invention;

FIG. 9 is a flowchart illustrating a method of handling a minimum bit width exception rule in accordance with embodiments of the present invention;

FIG. 10 is a flowchart illustrating a method of handling a clock driver exception rule in accordance with embodiments of the present invention; and

FIG. 11 is a flowchart illustrating a method of handling a node utilization exception rule in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

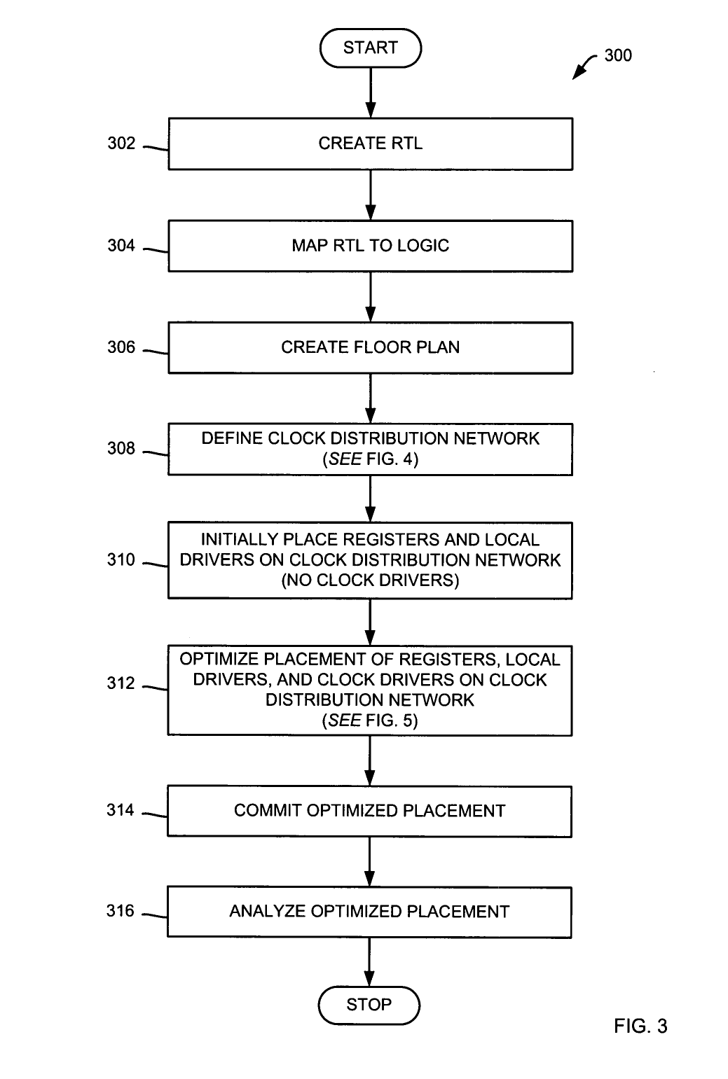

FIG. 3 is a flowchart illustrating an overview of creating an optimized clock distribution network 300 in accordance with embodiments of the present invention. In particular, the flowchart describes a work flow for creating embodiments of the present invention. The flowchart is intended to provide an overview and context within which embodiments of the present invention may be practiced. At least some of the steps described may be accomplished using any number of tools known in the art without departing from the present invention. At a first step 302, a register transfer language (RTL) representation of desired code or logic is created by a user. RTL is well-known in the art and is utilized to represent code or logic in a form that more resembles assembly language over higher level languages. Many tools exist to facilitate generation of RTL and may be utilized without limitation without departing from the present invention. As such, in some embodiments, an RTL module may be utilized for creating code expressions in RTL. At a next step 304, the method then maps the generated RTL to logic. That is, logic circuitry needed to fulfill the coding of the generated RTL is determined. As may be appreciated, logic circuitry may be flexibly configured utilizing existing tools. As such, in some embodiments, a synthesis module may be utilized for mapping the RTL to logic circuitry. At a next step 306, a floor plan may be created. A floor plan defines a physical space in which logic circuitry may reside. Generally, the physical space needed to accommodate the logic circuitry is not limited to a particular dimensional aspect ratio. Instead, only an absolute area is required when generating a floor plan. As such, in some embodiments, a floor plan module may be utilized for defining physical space requirements for the clock distribution network.

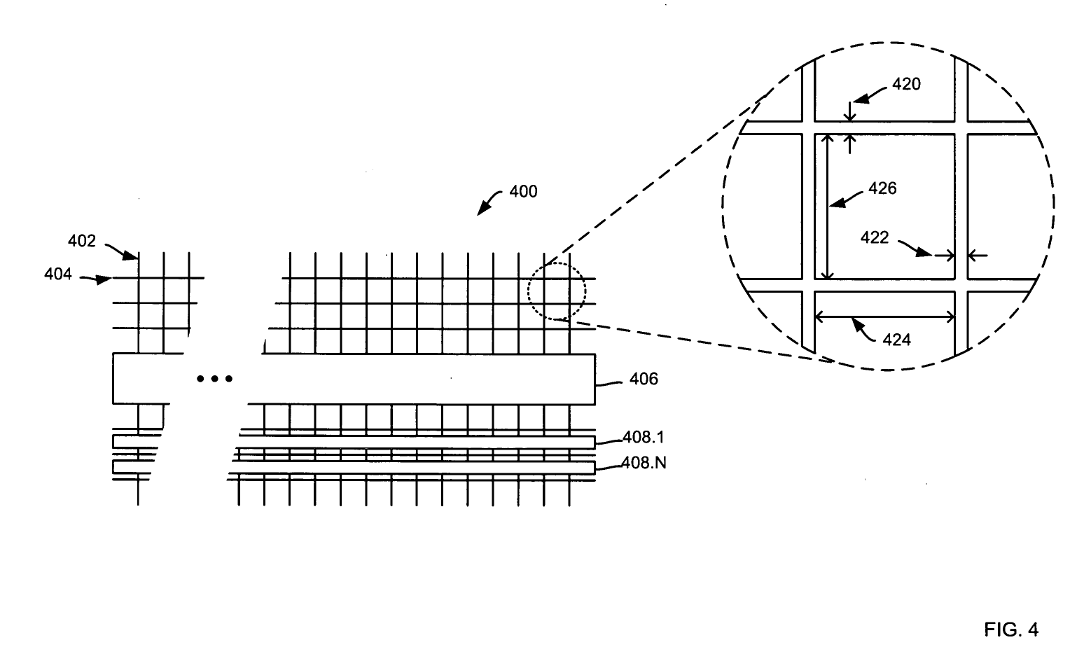

At a next step 308, a clock distribution network is defined. In some embodiments, the clock distribution network is a clock mesh synthesis. Defining a clock distribution network for a clock mesh synthesis includes defining mesh dimensions and reserving space for clocks in embodiments of the present invention. As such, in some embodiments, a clock grid design (CGD) floor plan module may be utilized for defining physical dimensions corresponding with the clock distribution network such that physical space requirements may be determined. Defining a clock distribution network is discussed in further detail below for FIG. 4. At a next step 310, logic and registers are initially placed on the clock distribution network defined at a step 308. No clock drivers, however, are initially placed in embodiments described herein. Logic (or local drivers) and associated registers may be initially placed in accordance with some defined criteria such as grouping by function. Many tools exist for initially placing logic and associated registers on a clock distribution network and may be utilized without limitation without departing from the present invention. As such, in some embodiments, a placement module may be utilized for initially placing local drivers and associated registers (e.g. features).

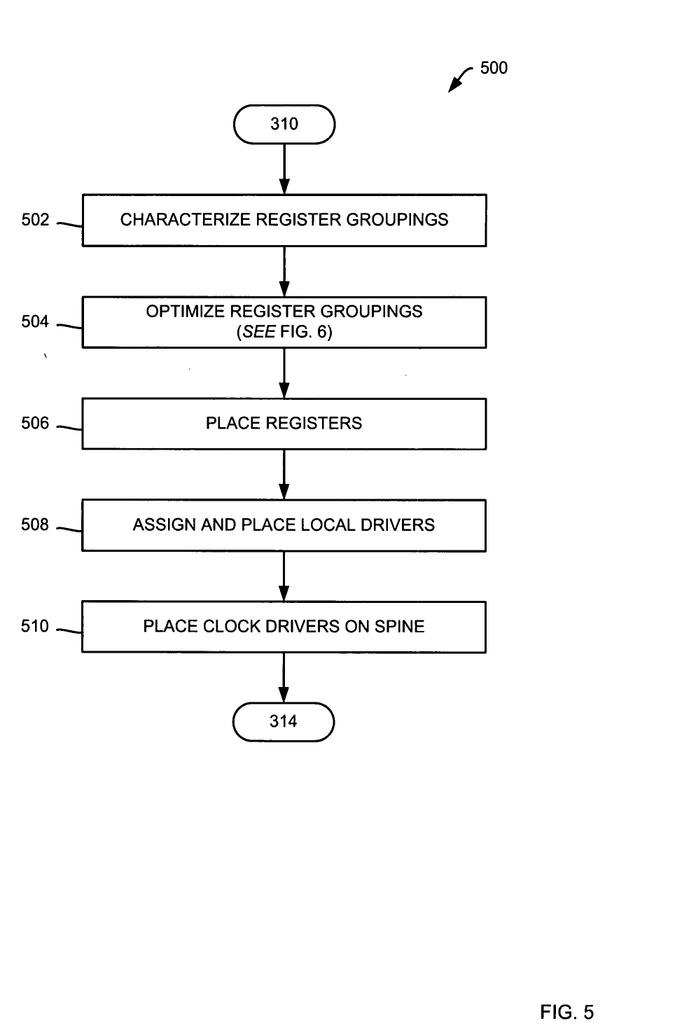

At a next step 312, the initial placement of logic and registers are optimally placed along with clock drivers in accordance with embodiments described herein. Optimized placement includes iteratively moving features in accordance with a number of exception based rules over an increasingly widening area of comparison. In some embodiments, optimal placement accounts for minimum bit width usage, local driver usage, and defined region usage generally. Optimized placement will be discussed in further detail below for FIG. 5. As such, in some embodiments, a CGD placement module may be utilized for optimizing the initial placement. At a next step 314, a layout or optimized placement is committed. Committing an optimized placement includes wiring features together to form a number of electronic connections. Committing an optimized placement also includes timing checks performed to assure that the clock distribution network is functioning properly. Many tools exist for committing an optimized placement and may be utilized without limitation without departing from the present invention. As such, in some embodiments, route module may be utilized for committing an optimized placement. At a next step 316, the optimized layout may optionally be analyzed. In some embodiments, analysis may be configured for Simulation Program for Integrated Circuits Emphasis (SPICE) compatibility. Many tools exist for analyzing an optimized placement and may be utilized without limitation without departing from the present invention. As such, in some embodiments, a CGD analysis module may be utilized for determining efficiency of the optimized placement. The method then ends.

FIG. 4 is an illustrative representation of a clock mesh synthesis 400 in accordance with embodiments of the present invention. In particular, FIG. 4 further describes a step 308 (FIG. 3). As noted above, in some embodiments, the clock distribution network is a clock mesh synthesis. Defining a clock distribution network for a clock mesh synthesis includes defining mesh dimensions and reserving space for clocks in embodiments of the present invention. Thus, defining a clock mesh synthesis includes defining a grid of columns (i.e. column 402) and rows (i.e. row 404). Further, each cell delimited by bounding rows and bounding columns is denoted as a defined region. A column, such as column 402 may include a column width dimension 422. Column width dimensions may be selected in accordance with user preferences and circuit design considerations without departing from the present invention. A row, such as row 404 may include a row width dimension 420. Row width dimensions may be selected in accordance with user specification without departing from the present invention. Further, columns may be arranged having a vertical pitch dimension 426. Vertical pitch dimensions may be selected in accordance with user specification without departing from the present invention. In addition, rows may be arranged having a horizontal pitch dimension 424. Horizontal pitch dimensions may be selected in accordance with user specification without departing from the present invention. Each cell delimited by a row and a column is a defined region. It may be appreciated that the dimensions of a vertical and a horizontal clock mesh pitches are generally independent of the size of a region. The dimensions of the vertical and horizontal clock mesh are determined based on the size and shape of the design and the overall number of registers in that design thus ensuring adequate power distribution. In general, the dimensions of a region are based on an acceptable amount of register physical displacement vis-à-vis the desired size of the register grouping.

Clock mesh synthesis 400 may further include a spine 406. Spine 406 is a defined physical space configured for receiving clock drivers. Clock drivers, as may be appreciated, provide a clock signal to any number of local rivers. Providing a dedicate physical space for clock drivers may provide some advantages for more efficient placement, which may reduce skew in some embodiments and provide more efficient power distribution in other embodiments. In other embodiments some power distribution efficiencies may be achieved by clustering clock drivers across a dedicated spine. Clock mesh synthesis 400 may further include a number of clock rows 408.1 to 408.N. Clock row 408.1, for example, is a defined physical space configured for receiving any number of local drivers and any number of decoupling capacitors. Providing a dedicated physical space for local drivers may provide some advantages for more efficient placement of drivers which may reduce skew in some embodiments and provide more efficient power distribution in other embodiments. Local drivers may include qualified drivers and unqualified drivers in some embodiments. Decoupling capacitors provide a local charge reservoir for avoiding voltage sag, which may cause timing anomalies. As illustrated, two clock rows are placed across adjacent rows, however, clock rows may be placed along any row in accordance with user preferences and circuit design considerations without departing from the present invention.

FIG. 5 is a flowchart further illustrating arranging features on a clock distribution network in accordance with embodiments of the present invention. In particular, FIG. 5 further describes a step 312 (FIG. 3). At a first step 502, register groupings of an initial placement are characterized. As noted above for a clock mesh synthesis, rows and columns are arranged in a grid pattern having a number of bounded areas called defined regions. In some embodiments, defined regions have a vertical pitch of approximately 60.48 μm and a horizontal pitch of approximately 60.48 μm. Each defined region may, in turn, be further characterized by groupings of registers located within those defined regions. In general, registers provide a memory location for storing data. In some embodiments, registers may be characterized by associated logic such as an unqualified driver or a qualified driver. Qualified drivers may be further characterized by enable net. That is, registers having functionally equivalent qualified drivers may be characterized by a single register grouping that have a same enable net. Characterization also returns the number of registers in each grouping and the physical area occupied by the registers in a register grouping. Register groupings of an initial placement may be utilized as a basis for determining more optimal groupings as described below. In general, characterization marks the appropriate exceptions per region which are then used to drive the optimization that is described below.

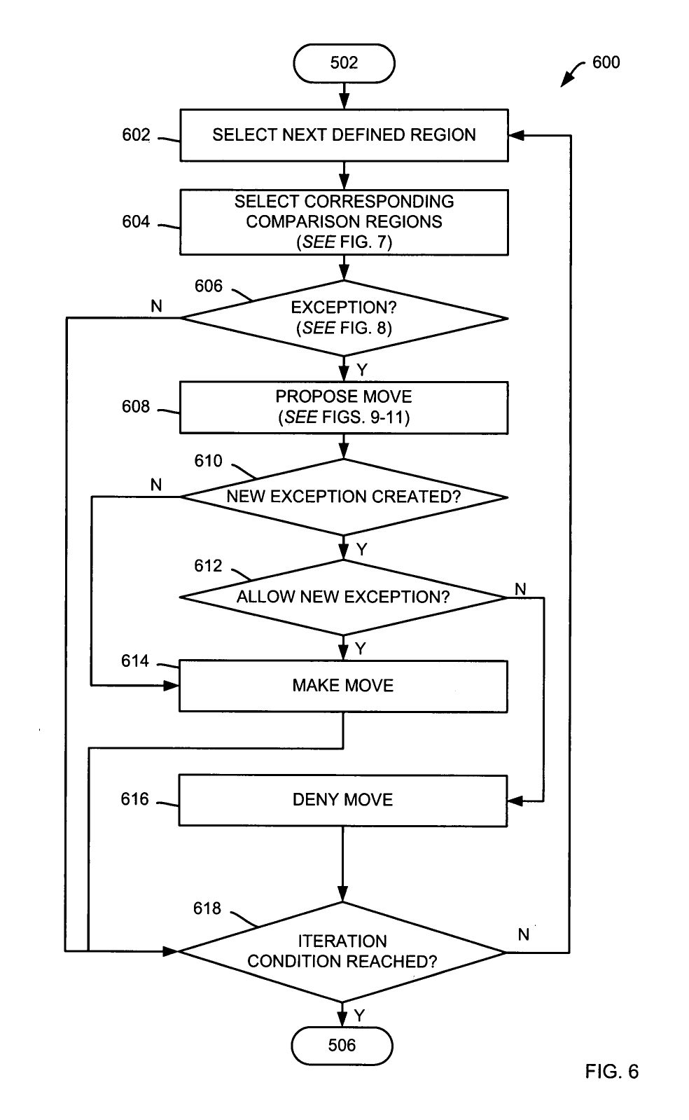

At a next step 504, the method optimizes register groupings. Optimizing register groupings utilizing embodiments described herein may provide physical space improvements, signal distribution improvements, and skew improvements. Further, by grouping registers, less circuitry may be utilized to drive the same number of registers over an initial placement. Optimizing register groupings are described in further detail below for FIG. 6. At a next step 506, registers are placed on a clock distribution network in accordance with optimized register groupings. Placing a register includes selecting a physical location. In some embodiments, at least one guiding principal in placing a register is to provide minimal movement when enforcing exception based rules. Minimizing movement will tend to avoid creating more problems than are being solved by optimization processes. At a next step 508, local drivers are assigned and placed. Local drivers are the logic which utilizes registers for data storage. Local drivers may be qualified or unqualified in some embodiments. Qualified drivers may include an AND gate in some embodiments. In some embodiments, qualified drivers may be further grouped in same enable nets. An enable net provides a signal for functionally equivalent logic.

At a next step 510, the method places clock drivers on the spine. As noted above, a spine is a defined physical space configured for receiving clock drivers. Clock drivers, as may be appreciated, provide a clock signal to any number of local drivers. Providing a dedicate physical space for clock drivers may provide some advantages for more efficient placement, which may reduce skew in some embodiments and provide more efficient power distribution in other embodiments. In other embodiments some power distribution efficiencies may be achieved by clustering clock drivers across a dedicated spine. The method then continues to a step 314 (see FIG. 3).

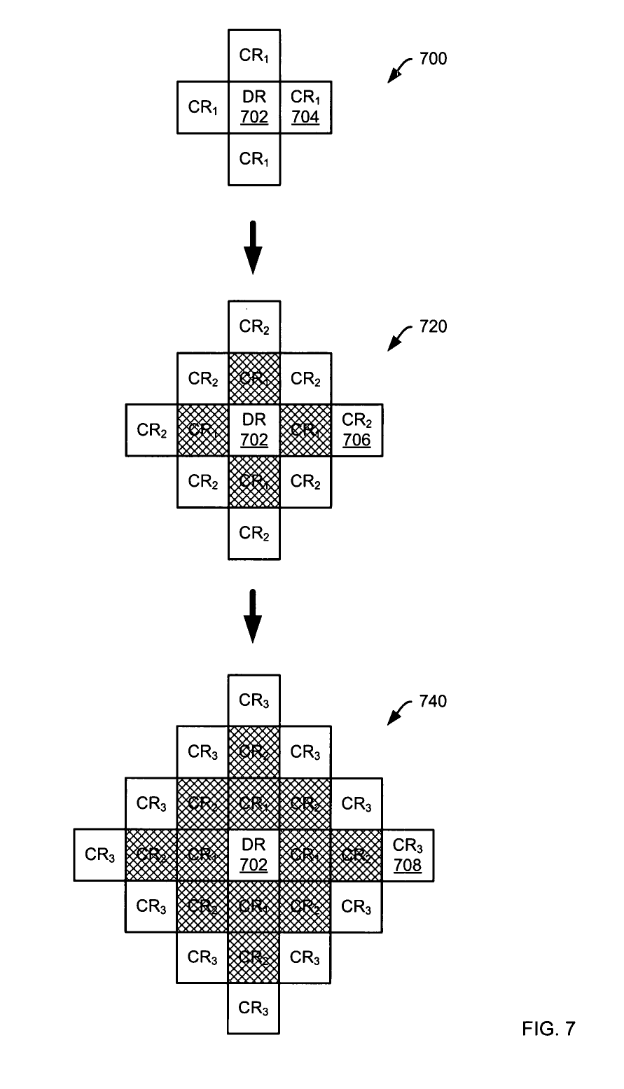

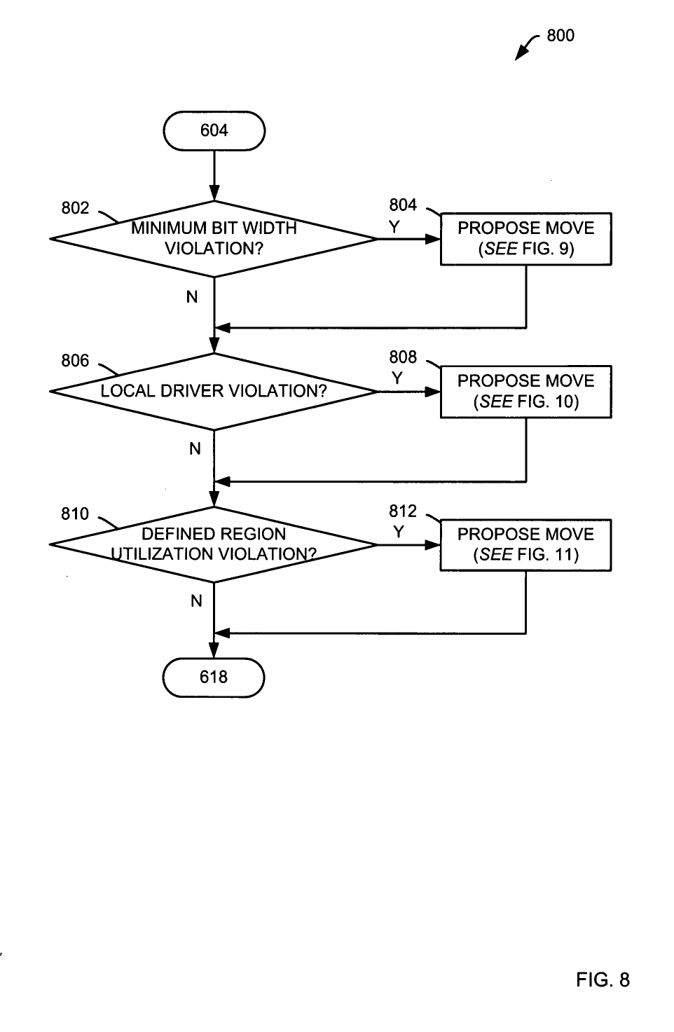

FIG. 6 is a flowchart illustrating methods of applying iterative exception based rules 600 in accordance with embodiments of the present invention. In particular, FIG. 6 further describes a step 504 (FIG. 5). At a first step 602, the method selects a next defined region. As noted above, in some embodiments, the clock distribution network is a clock mesh synthesis. Defining a clock distribution network for a clock mesh synthesis includes defining mesh dimensions and reserving space for clock drivers and local drivers in embodiments of the present invention. Thus, defining a clock mesh synthesis includes defining a grid of columns (i.e. column 402, FIG. 4) and rows (i.e. row 404, FIG. 4). Further, each cell delimited by bounding rows and bounding columns is denoted as a defined region. Methods described herein examine each defined region in a clock mesh synthesis. In some embodiments, examination of defined regions may proceed sequentially through a clock mesh synthesis. In other embodiments, examination of defined regions may proceed randomly though a clock mesh synthesis. At a next step 604, the method selects corresponding comparison regions for a defined region. Comparison regions are described in further detail below for FIG. 7. At a next step, the method determines whether an exception has occurred. As noted above, methods described herein are based exception based rules. Exception based rules are described in further detail below for FIG. 8.

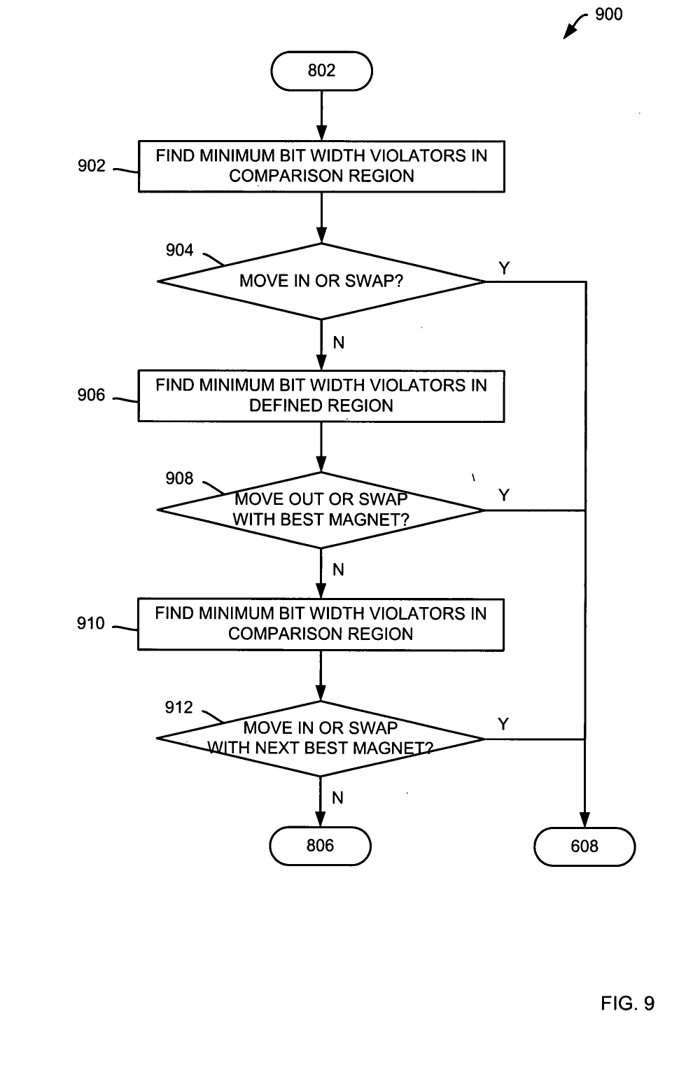

If the method determines at a step 606 that an exception has not occurred, the method continues to a step 618 to determine whether an iteration condition has been reached. If the method determines at a step 606 that an exception has occurred, then the method proceeds to a step 608 to propose a move. A move may include a move in, a move out, or a swap. Moves are discussed in further detail below for FIGS. 9-11. At a next step 610, the method determines whether a new exception is created by the move proposed at a step 608. Generally speaking creating a new exception while attempting to resolve an exception is not desirable. However, in some embodiments, a new exception may be allowable. Thus, if the method determines at a step 610 that a new exception is not created, then the method makes the proposed move at a step 614 whereupon the method continues to a step 618. If the method determines at a step 610 that a new exception has been created, then the method continues to a step 612 to determine whether to allow the new exception. In some examples, a user may select whether to allow a new exception as a result of a proposed move in accordance with user preferences. In some embodiments, a new exception is not allowed at a first level of comparison and a second level of comparison. In some embodiments, a new exception may be selectively allowed at a third level of comparison. If the method determines at a step 612 to allow a new exception, then the method continues to a step 614 to make the proposed move whereupon the method continues to a step 618. If the method determines at a step 612 to deny the new exception, then the method continues to a step 616 to deny the proposed move whereupon the method continues to a step 618.

At a step 618, the method determines whether an iteration condition has been reached. In some embodiments, iteration conditions include: an all exceptions cleared condition for an area of comparison, an all exceptions processed condition for an area of comparison, and a maximum number of iteration condition for an area of comparison. An all exceptions cleared condition for an area of comparison is a condition that provides for repeatedly examining all defined regions each having a widening area of comparison until all exceptions are cleared or resolved at every level of comparison. An all exceptions processed condition for an area of comparison is a condition that provides for repeatedly examining all defined regions each having a widening area of comparison until all exceptions are processed at every level of comparison. That is, in some examples, an exception may not be resolvable. In those examples, examination may be configured to stop when all exceptions have been at least processed. A maximum number of iterations condition for an area of comparison is a condition that provides for repeatedly examining all defined regions each having a widening area of comparison a specified number of times. This condition may be useful in avoiding an endless loop. If the method determines at a step 618 that an iteration condition has not been reached, then the method continues to a step 602 to select a next defined region. If the method determines at a step 618 that an iteration condition has been reached, the method continues to a step 506 (see FIG. 5).

FIG. 7 is an illustrative representation of widening areas of comparison 700 in accordance with embodiments of the present invention. In particular, FIG. 7 further illustrates comparison regions as noted in a step 604 (see FIG. 6). In some embodiments, first level of comparison 700 includes defined region 702 and a number of relevant comparison regions as, for example, relevant comparison region 704. As may be seen relevant comparison regions at a first level of comparison 700 are located immediately adjacent with defined region 702. In some embodiments, a second level of comparison 720 includes defined region 702 and a number of relevant comparison regions as, for example, relevant comparison region 706. As may be seen relevant comparison regions at a second level of comparison 720 are located immediately adjacent with relevant comparison regions from first level of comparison 700. In some embodiments, comparison at a second level of comparison includes relevant comparison regions corresponding with a first level of comparison. As such, comparisons are cumulative. In some embodiments, third level of comparison 740 includes defined region 702 and a number of relevant comparison regions as, for example, relevant comparison region 708. As may be seen relevant comparison regions at third level of comparison 740 are located immediately adjacent with relevant comparison regions from second level of comparison 720. In some embodiments, comparison at a third level of comparison includes relevant comparison regions corresponding with a second level of comparison and a first level of comparison. As such, comparisons are cumulative. As may be appreciated, at each widening are of comparison, the number of relevant comparison regions increases which provides more opportunities to correct an exception, but may accordingly require more processing effort and increase register displacement in some examples.

FIG. 8 is a flowchart illustrating methods of applying exception based rules 800 in accordance with embodiments of the present invention. In particular, FIG. 8 further describes a step 606 (see FIG. 6). At a first step 802, the method determines whether a minimum bit width violation has occurred. A minimum bit width violation occurs when a minimum number of registers are not associated with a corresponding local driver. In some embodiments, a minimum bit width violation occurs when less than three registers are associated with a corresponding local driver. Minimum bit width may provide a usage model that provides a minimum efficiency in terms of physical space and local driver utilization. If the method determines at a step 802 that a minimum bit width violation has occurred, then the method continues to a step 804 to propose a move. A proposed move for a minimum bit width violation is discussed in further detail below for FIG. 9.

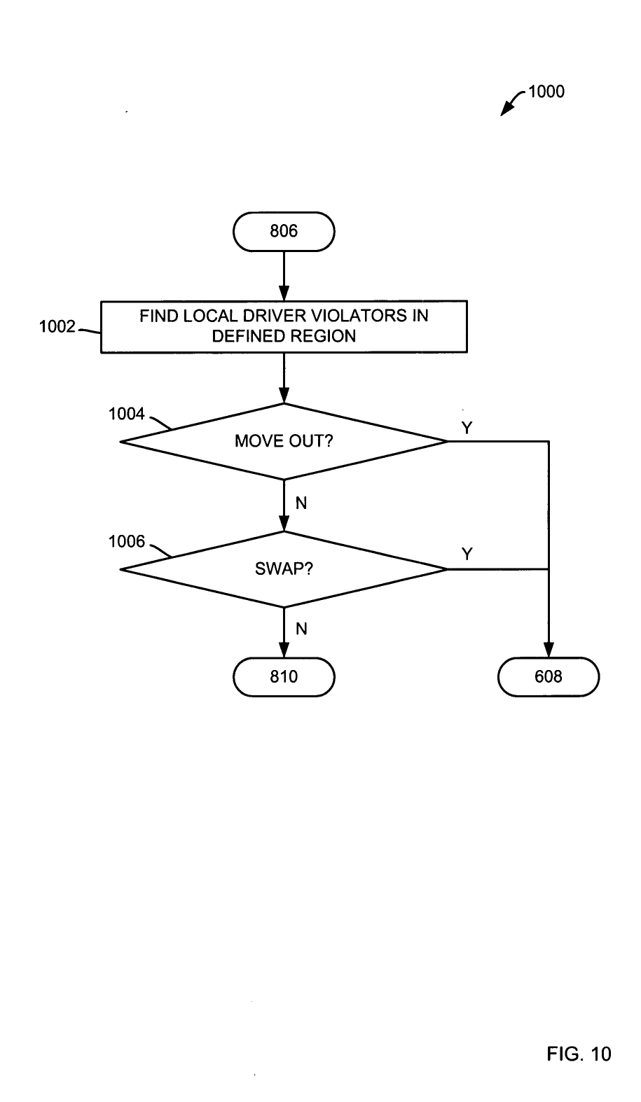

If the method determines at a step 802 that a minimum bit width violation has not occurred, then the method continues to a step 806 to determine whether a local driver violation has occurred. A local driver violation occurs when the number of local drivers for a defined region is exceeds the physical space available. As noted above, local drivers may be placed on a clock row. Optimally, local drivers should be as physically proximal as possible with associated registers. In some instances, where the number of different register groupings in a defined region is high, then the number of local drivers needed to drive the register groupings may exceed the capacity of the clock row located proximate to the defined region. In those instances, it may be desirable to propose a move. If the method determines at a step 806 that a local driver violation has occurred, then the method continues to a step 808 to propose a move. A proposed move for a local driver violation is discussed in further detail below for FIG. 10.

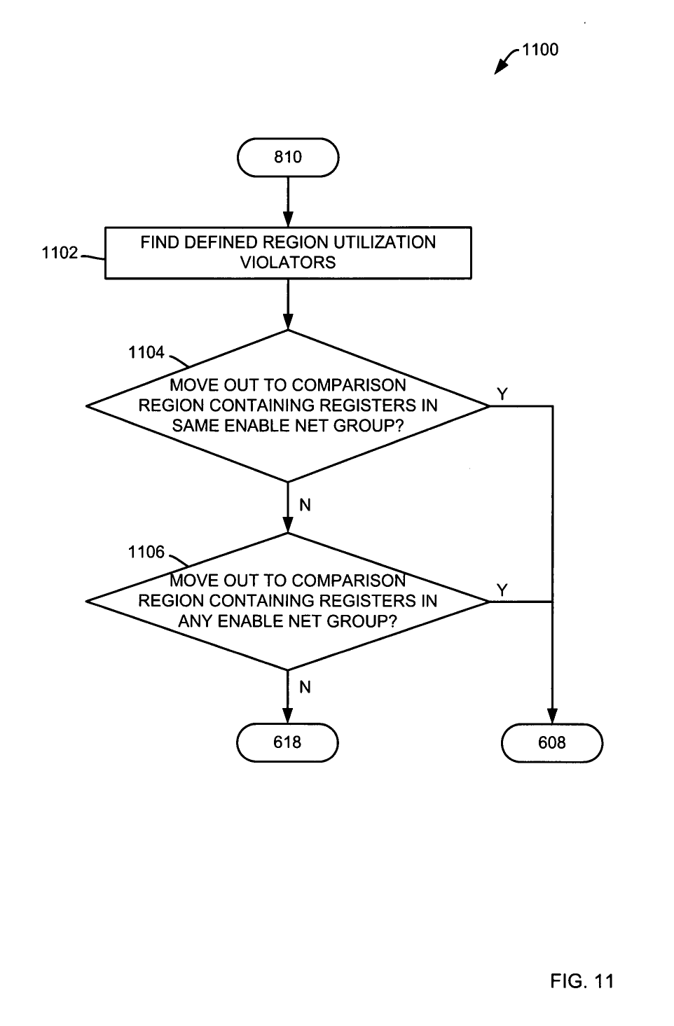

If the method determines at a step 806 that a local driver violation has not occurred, then the method continues to a step 810 to determine whether a defined region utilization violation has occurred. A defined region utilization violation occurs when the number of registers placed in a defined region exceeds the physical space available. In those instances, it may be desirable to propose a move. It may be appreciated that available space is generally dependent on register size and mesh dimensions. Thus, if the method determines at a step 810 that a defined region utilization violation has occurred, then the method continues to a step 812 to propose a move. A proposed move for a defined region utilization violation is discussed in further detail below for FIG. 11. If the method determines that a defined region utilization violation has not occurred, then the method continues to a step 618 (see FIG. 6).

FIG. 9 is a flowchart illustrating a method of handling a minimum bit width exception rule 900 in accordance with embodiments of the present invention; In particular, FIG. 9 further describes a step 804 (see FIG. 8). As noted above, a minimum bit width violation occurs when a minimum number of registers are not associated with a corresponding local driver. As such, at a first step 902, for each defined region, the method finds any minimum bit width violators in a relevant comparison region. A relevant comparison region may correspond with any of a first level of comparison, a second level of comparison, and a third level of comparison as described above for FIG. 7. Each level of comparison includes a plurality of relevant comparison regions. If a minimum bit width violator is found in a relevant comparison region, then the method determines at a step 904 whether to move in the violator from the relevant comparison region into the defined region or to swap the violator from the relevant comparison region with a register in the defined region. A swap in this example is an extension of a move in scenario. In a move in scenario minimum bit width violating registers are moved into a defined region from a comparison region which contains a number of registers on the same enable net grouping. If the move in is not possible because the defined region does not have sufficient space, then a swap is attempted. At this point, the method will attempt to find registers in the defined region to move out to the comparison region, thus creating space for registers in the defined region. In some embodiments, registers being moved out must be from an enable net group already contained in the comparison region and of a number so as not to exceed the region utilization in that comparison region. In some embodiments, if a move in or swap results in a defined region utilization violation, then the exception may not be immediately curable. If the method determines that a move in or swap may occur, then the method proceeds to a step 608 (see FIG. 6).

If the method determines that a move in or swap may not occur, the method proceeds to a step 906 to find any bit width violators in the defined region. If a minimum bit width violator is found, then the method determines at a step 908 whether the violator may be moved out or swapped with a best magnet in a relevant comparison region. A best magnet is defined, for purposes of this application, as a local driver having the highest degree of fan out. In order to move out or swap, a relevant comparison region must have both a nearby local driver and the move must not cause another exception. If the method determines that a move out or swap may occur, then the method proceeds to a step 608 to propose a move (see FIG. 6).

If the method determines that a move out or swap may not occur, the method proceeds to a step 910, where for each defined region, the method finds any minimum bit width violators in a relevant comparison region. If a minimum bit width violator is found in a relevant comparison region, then the method determines at a step 912 whether to move in the violator from the relevant comparison region into a second best magnet in the defined region or to swap the violator from the relevant comparison region with a register in the defined region. As above, a swap in this example is an extension of a move in scenario. In a move in scenario minimum bit width violating registers are moved into a defined region from a comparison region which contains a number of registers on the same enable net grouping. If the move in is not possible because the defined region does not have sufficient space, then a swap is attempted. At this point, the method will attempt to find registers in the defined region to move out to the comparison region, thus creating space for registers in the defined region. In some embodiments, registers being moved out must be from an enable net group already contained in the comparison region and of a number so as not to exceed the region utilization in that comparison region. In some embodiments, if a move in or swap results in a defined region utilization violation, then the exception may not be immediately curable. If the method determines that a move in or swap may occur, then the method proceeds to a step 608 to propose a move (see FIG. 6). If the method determines that a move in or swap may not occur, the method proceeds to a step 806 (see FIG. 8).

FIG. 10 is a flowchart illustrating a method of handling a local driver exception rule 1000 in accordance with embodiments of the present invention. In particular, FIG. 10 further describes a step 808 (see FIG. 8). As noted above, a local driver violation occurs when the number of local drivers for a defined region is exceeds the physical space available. As such, at a first step 1002 the method finds all local driver violators in a defined region. The method then determines at a step 1004 whether a local driver violator may be moved out of the defined region to a relevant comparison region. As noted above, a relevant comparison region may correspond with any of a first level of comparison, a second level of comparison, and a third level of comparison as described above for FIG. 7. Each level of comparison includes a plurality of relevant comparison regions. A local driver violator may not be moved to a relevant comparison region if the move causes a second local driver violation in the relevant comparison region (or any other exception type). If the method determines at a step 1004 that a move out is possible, then the method continues to a step 608 to propose a move (see FIG. 6). If the method determines that a move out is not possible, then the method determines at a step 1006 whether a swap is possible with a relevant comparison region. If the method determines at a step 1006 that a swap is possible, then the method continues to a step 608 to propose a move (see FIG. 6). If the method determines at a step 1006 that a swap is not possible, then the method continues to a step 810 (see FIG. 8).

FIG. 11 is a flowchart illustrating a method of handling a defined region utilization exception rule in accordance with embodiments of the present invention. In particular, FIG. 11 further describes a step 812 (see FIG. 8). As noted above, a defined region utilization violation occurs when the number of registers placed in a defined region exceeds the physical space available. As such, at a first step 1102, the method finds all defined region utilization violators in a defined region. The method then determines at a step 1104 whether a defined region utilization violator may be moved to a relevant comparison region containing registers in a same enable net group. As noted above, a relevant comparison region may correspond with any of a first level of comparison, a second level of comparison, and a third level of comparison as described above for FIG. 7. Each level of comparison includes a plurality of relevant comparison regions. If the method determines at a step 1104 that a move out is possible, then the method continues to a step 608 to propose a move (see FIG. 6). If the method determines at a step 1104 that a move out is not possible, then the method determines whether a defined region utilization violator may be moved to a relevant comparison region containing registers in any enable net group. If the method determines at a step 1106 that a move out is possible, then the method continues to a step 608 to propose a move (see FIG. 6). If the method determines at a step 1106 that a move out is not possible, then the method continues to a step 618 (see FIG. 6).

While this invention has been described in terms of several preferred embodiments, there are alterations, permutations, and equivalents, which fall within the scope of this invention. It should also be noted that there are many alternative ways of implementing the methods and apparatuses of the present invention. Although various examples are provided herein, it is intended that these examples be illustrative and not limiting with respect to the invention. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A method for optimizing an initial placement a plurality of features over a clock signal distribution network on an integrated circuit (IC), wherein the plurality of features includes a plurality of registers and a corresponding plurality of local drivers, the method comprising:
characterizing the plurality of features by a plurality of register groupings, the plurality of register groupings defined by similarity of corresponding local drivers, wherein each of the plurality of register groupings is physically delimited by a defined region on the clock signal distribution network in the initial placement; and
iteratively moving the plurality of register groupings in accordance with a plurality of exception based rules over an increasingly widening area of comparison to create an optimized placement of the plurality of features.

2. The method of claim 1 further comprising:
placing the plurality of register groupings on the clock signal distribution network in accordance with the iteratively moving the plurality of register groupings;
placing the corresponding plurality of local drivers on a clock row in accordance with the placing the plurality of register groupings;
placing a plurality of clock drivers on a spine region, the plurality of clock drivers configured to provide the corresponding plurality of drivers a common clock signal; and
placing a plurality of routes, the plurality of routes configured to connect the plurality of clock drivers with the corresponding plurality of local drivers and the plurality of corresponding local drivers with the plurality of register groupings.

3. The method of claim 1 further comprising;
generating a quality report for determining a plurality of performance characteristics corresponding with the optimized placement.

4. The method of claim 1 wherein the increasingly widening area of comparison comprises:
a first level of comparison, wherein the first level of comparison requires that the plurality of exception based rules are strictly enforced, and wherein the plurality of exception based rules are iteratively and repeatedly applied across all defined regions until none of the plurality of exception based rules are enforceable, the first level of comparison corresponding with a first plurality of comparison regions, the first plurality of comparison regions located immediately adjacent with the defined region;
a second level of comparison, wherein the second level of comparison requires that the plurality of exception based rules are strictly enforced, and wherein the plurality of exception based rules are iteratively and repeatedly applied across all defined regions until none of the plurality of exception based rules are enforceable, the second level of comparison corresponding with a second plurality of comparison regions and the first level of comparison regions, the second plurality of comparison regions located immediate adjacent with the first plurality of comparison regions; and
a third level of comparison, wherein the third level of comparison requires that the plurality of exception based rules are selectively enforced, and wherein the plurality of exception based rules are iteratively and repeatedly applied across all defined regions until none of the plurality of exception based rules are enforceable, the third level of comparison corresponding with a third plurality of comparison regions, the second plurality of comparison regions, and the first plurality of comparison regions, the third plurality of comparison regions located immediate adjacent with the second plurality of comparison regions.

5. The method of claim 4 wherein the plurality of exception based rules is selected from the group consisting of: a minimum bit width exception rule, a local driver exception rule, and a defined region utilization exception rule.

6. The method of claim 5 wherein the enforcing the minimum bit width exception rule comprises:
finding a minimum bit width violator in a relevant comparison region, wherein the relevant comparison region alternately corresponds with the first level of comparison, the second level of comparison, and the third level of comparison;
moving the minimum bit width violator into the defined region, wherein the minimum bit width violator is moved to a location proximal with a first local driver, the first local driver having the highest fan out;
if the moving creates a new violation,
alternatively swapping the minimum bit width violator into the defined region; and
if the swapping creates the new violation,
alternatively ignoring the minimum bit width violator.

7. The method of claim 6 wherein the enforcing the minimum bit width exception rule further comprises:
finding the minimum bit width violator in the defined region;
if the minimum bit width violator is located within a defined distance from a second local driver and the relevant comparison includes an area sufficiently sized to receive the minimum bit width violator,
moving the minimum bit width violator into the relevant comparison region wherein the minimum bit width violator is moved to a location proximal with the second local driver;
if the moving creates the new violation,
alternatively swapping the minimum bit width violator into the relevant comparison region; and
if the swapping creates the new violation,
alternatively ignoring the minimum bit width violator.

8. The method of claim 7 wherein the enforcing the minimum bit width exception rule further comprises:
finding the minimum bit width violator in a relevant comparison region, wherein the relevant comparison region alternately corresponds with the first level of comparison, the second level of comparison, and the third level of comparison;
moving the minimum bit width violator into the defined region, wherein the minimum bit width violator is located proximal with a third local driver, the third local driver having a second highest fan out;
if the moving creates the new violation,
alternatively swapping the minimum bit width violator into the defined region; and
if the swapping creates the new violation,
alternatively ignoring the minimum bit width violator.

9. The method of claim 5 wherein enforcing the local driver exception rule comprises:
finding a local driver violator in the defined region;
moving the local driver violator into a relevant comparison region, wherein the relevant comparison region alternately corresponds with the first level of comparison, the second level of comparison, and the third level of comparison;
if the moving creates the new violation,
alternatively swapping the local driver violator into the relevant comparison region; and
if a total number of local drivers does not decrease with the swapping,
alternatively ignoring the local driver violator

10. The method of claim 5 wherein enforcing the defined region utilization exception rule comprises:
finding a defined region utilization violator in the defined region;
moving the defined region utilization violator into a relevant comparison region, the relevant comparison region having a subset of registers of a same enable net group, wherein the relevant comparison region alternately corresponds with the first level of comparison, the second level of comparison, and the third level of comparison;
if the moving creates the new violation or if the relevant comparison region lacks the same enable net group;
alternatively moving the defined region utilization violator into the relevant comparison region; and
if the moving creates the new violation,
alternatively ignoring the defined region utilization violator.

11. The method of claim 1 wherein clock signal distribution network is MIPS compliant.

12. The method of claim 1 wherein the clock signal distribution network is configured as a clock mesh synthesis.

13. The method of claim 1 wherein the plurality of features is selected from the group consisting of: an AND gate, a buffer, an inverter, and a register.

14. The method of claim 1 wherein the iteratively moving continues until an iteration condition is reached, wherein the iteration condition is selected from the group consisting of: an all exceptions cleared condition for an area of comparison, an all exceptions processed condition for the area of comparison, and a maximum number of iterations condition for the area of comparison.

15. The method of claim 1 wherein the corresponding plurality of local drivers includes at least one unqualified driver and at least one qualified driver.

16. A system for optimizing an initial placement of a plurality of features over a clock signal distribution network on an integrated circuit (IC) layout, wherein the plurality of features includes a plurality of registers and a corresponding plurality of local drivers, the system comprising:
a register transfer language (RTL) module for creating a plurality of code expressions in an RTL;
a synthesis module for mapping the RTL to a plurality of logic circuits based on a first output from the RTL module;
a floor plan module for determining a first physical space requirement for the clock signal distribution network based on a second output from the synthesis module;
a clock grid design (CGD) floor plan module for defining a set of physical dimensions corresponding with the clock signal distribution network based on a third output from the floor plan module, the CGD floor plan module further configured for determining a second physical space requirement for the plurality of local drivers corresponding with the plurality of logic circuits;
a placement module for creating the initial placement of the plurality of features,
a CGD placement module for optimizing the initial placement, the CGD configured to,
group the plurality of registers in accordance with a plurality of iteratively applied exception based rules,
place the plurality of local drivers, and
place a plurality of clock drivers; and
a route module for establishing a plurality of connections between the plurality of registers, the plurality of local drivers, and the plurality of c wherein an optimized placement is output.

17. The system of claim 16 further comprising:
a CGD analysis module for determining an efficiency of an optimized placement.

18. The system of claim 17 wherein the CGD analysis module is configured to provide Simulation Program for Integrated Circuits Emphasis (SPICE) support.

19. A method for optimizing an initial placement a plurality of features over a clock signal distribution network on an integrated circuit (IC), wherein the plurality of features includes a plurality of registers and a corresponding plurality of local drivers, the method comprising:
means for characterizing the plurality of features by a plurality of register groupings, the plurality of register groupings defined by similarity of corresponding local drivers, wherein each of the plurality of register groupings is physically delimited by a defined region on the clock signal distribution network in the initial placement; and
means for iteratively moving the plurality of register groupings in accordance with a plurality of exception based rules over an increasingly widening area of comparison to create an optimized placement of the plurality of features.

20. The method of claim 19 further comprising:
means for placing the plurality of register groupings on the clock signal distribution network in accordance with the means for iteratively moving the plurality of register groupings;
means for placing the corresponding plurality of local drivers on a clock row in accordance with the placing the plurality of register groupings;
means for placing a plurality of clock drivers on a spine region, the plurality of clock drivers configured to provide the corresponding plurality of drivers a common clock signal; and
means for placing a plurality of routes, the plurality of routes configured to connect the plurality of clock drivers with the corresponding plurality of local drivers and the plurality of corresponding local drivers with the plurality of register groupings.

21. The method of claim 19 further comprising:
means for generating a quality report for determining a plurality of performance characteristics corresponding with the optimized placement.
